(19) United States
(12) Patent Application Publication
(10) Pub. No.: US 2019/0028739 A1
(43) Pub. Date: Jan. 24, 2019

(54) CONTENT RATING SYSTEM IMPLEMENTATION USING LICENSE ROTATION

(71) Applicant: OpenTV, Inc., San Francisco, CA (US)

(72) Inventors: Debra Hensgen, San Jose, CA (US); Charles Stevens, Mountain View, CA (US)

(21) Appl. No.: 15/653,191

(22) Filed: Jul. 18, 2017

(51) Int. Cl. H04N 21/23; H04N 21/43; H04N 21/80; H04N 21/258; H04N 21/643; G06F 17/30

(52) U.S. Cl. CPC H04N 21/23; H04N 21/43; G06F 17/3053; H04N 21/25808; H04N 21/643; H04N 21/80

(57) ABSTRACT

Systems and methods for providing access to live content based on content rating levels are provided. A digital receiver receives an indication of a license rotation during presentation of a live content stream delivered over the Internet to the digital receiver of a user. In response to receiving the indication, the digital receiver accesses, from a license server, a license corresponding to the license rotation. The digital receiver extracts a rating level of content from a field of the license and compares a user setting for the user with the rating level of the content. Based on the comparing, the digital receiver determines whether to provide continued access to the live content stream.

### FIELD

The present disclosure generally relates to machines configured to the technical field of special-purpose machines that manage access to digital content including computerized variants of such special-purpose machines and improvements to such variants, and to the technologies by which such special-purpose machines become improved compared to other special-purpose machines for providing access to digital content based on a content rating system using license rotation.

### BACKGROUND

As presentation of live content is moving from broadcast to over-the-top (OTT), the same problems in broadcast must be addressed by OTT. However, different solutions are called for in the OTT world from those used in the broadcast live world. One particular problem that was solved in broadcast was that of allowing parental rating levels (e.g., parental guidance values, such as, TV-PG and TV-MA) of a content rating system to change at event boundaries when an earlier event can have a variable end time, while ensuring that not a single frame of a second event is seen by a viewer unless a user rating setting is sufficiently high to allow the viewer to view the second event (e.g., viewer setting allows viewer to view lower rated or higher/more mature content). In the broadcast world, this is a sufficiently important problem solved by standards defining fields (e.g., signalling) that are broadcast in-band with the content. Since these fields are packaged in a manner that is common to other signalling fields in MPEG-2 transport streams, and since set-top boxes have specific hardware for filtering such data fields, the box can very quickly detect a change in rating and prevent the viewer from viewing content not appropriate for the current setting. However, a similar technique is not currently available in the OTT world that is sufficiently robust to prevent inadvertent content from being viewed.

MPEG-2 based systems transport additional metadata. This would be prohibitive in the OTT world as the metadata would consume valuable bandwidth that could reduce the video quality on the OTT when a similar method is employed. There are two ways for transporting the maturity level currently in use and/or proposed for the OTT world. Since this information is signaled in either the catalog or the manifest file, both of which are typically fetched only when beginning to watch video available at a given URL or at preset times, they are not sufficient for signaling maturity level changes that can occur at arbitrary times. There is a facility in the advanced DASH IOP to signal within the video that the manifest file has been updated and should be refreshed, but (1) that IOP is not widely supported; (2) may likely require hardware changes to set-top boxes in order to identify this information within the hardware decoder; and (3) the delay associated with re-fetching the manifest file “after the fact” may allow inappropriate content to be viewed

### BRIEF DESCRIPTION OF DRAWINGS

Various ones of the appended drawings merely illustrate example embodiments of the present invention and cannot be considered as limiting its scope.

FIG. 1 is a diagram illustrating a current environment for providing access to live content over the Internet based on a user setting and a rating level of the live content;

FIG. 2 is a block diagram illustrating an example embodiment of components within a digital receiver.

FIG. 3 is a flow diagram of a method for providing access to live content based on license rotation in accordance with example embodiments.

FIG. 4 is a flow diagram of a method for providing access to live content using links in accordance with example embodiments.

FIG. 5 is a flow diagram of an alternative method for providing access to live content using links in accordance with example embodiments.

FIG. 6 is a diagrammatic representation of a machine in an example form of a computing system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the present inventive subject matter. In the following description, for purposes of explanation, numerous specific details are set forth in order to provide an understanding of various embodiments of the inventive subject matter. It will be evident, however, to those skilled in the art, that embodiments of the inventive subject matter may be practiced without some or other of these specific details. In general, well-known instruction instances, protocols, structures, and techniques have not been shown in detail. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

OTT live, like OTT for video-on demand (VoD), is being used to provide real-time (live) content to set-top boxes and other devices. The encoding of choice is settling toward MP4, instead of MPEG-2. Further, an adaptive bitrate protocol that is expected to be more prevalent is MPEG DASH—in particular either the DASH IF Interoperability Points (IOPs) and, in Europe at least, the DVB DASH IOPs. When using OTT for VoD, where events are pre-recorded with known lengths, it is sufficient to store the content rating level (e.g., parental guidance rating) for content (also referred to herein as “a content item” (e.g., a video, movie, program)) in a catalog. When a user wants to play a particular content item, prior to even fetching the content item (from a URL indicated in the catalog), the system checks that a user setting (e.g., a current parental guidance rating for the user) is sufficient to allow viewing before starting playback. In some cases, the user is queried to change the user setting by entering an access code (e.g., a password or PIN).

However, for OTT live, while the event information is kept on a catalog server separate from the CDNs (content delivery networks), where synchronization is not easy to maintain across time zones and multiple servers talking to a same client, the different clients and servers may well be out of synch. When an event terminates at an unscheduled time (e.g. a special news program that over runs or a sporting event that is rained out or extended), clients and servers must be informed at the same time if a new event with a different rating level (e.g., a different parental guidance rating) is going to start in order to prevent content being shown to users/viewers whose current setting is below the rating level associated with the content, or to prevent viewers missing an end of a close sporting event that runs over because a request to enter an access code is displayed over a blacked out screen prematurely.

Example methods (e.g., algorithms) facilitate providing access to live content over the Internet (e.g., using OTT) based on a user setting and a rating level of the live content, and example systems (e.g., special-purpose machines) are configured to provide access to live content over the Internet based on a user setting and a rating level of the live content. In particular, example embodiments provide mechanisms and logic that receives an indication of a license rotation during presentation of a live content stream delivered over the Internet to a viewing device of a user. In response to receiving the indication, the mechanisms and logic accesses, from a license server, a license corresponding to the license rotation and extracts a rating level of content from a field of the license. The mechanisms and logic determines whether a user setting for the user is equal to or greater than the rating level of the content. Based on the user setting being equal to or greater than the rating level of the content, the mechanisms and logic provides continued access to the live content stream. Conversely, based on the user setting being less than the rating level of the content, the continued access is blocked.

In alternative example embodiments, a content distribution network (CDN) server maintains or breaks content links based on the user setting. The CDN server initially associates different links (e.g., URLs) to content (or manifests of content). The CDN server receives a request for a particular link that implies a user setting, and provides the requested link. In example embodiments, when the client's rating (e.g., rating of a user of a digital receiver) changes, the client (e.g., digital receiver) terminates its request for the previous link and asks for a new link that corresponds to the new rating. If the content rating changes, the CDN server 108 detects the change in the content rating level, and provides a different set of links (e.g., links that correspond to the new content and its different rating).

As a result, one or more of the methodologies described herein facilitate solving the technical problem of providing access to live digital content that is being streamed over the Internet based on a content rating system, whereby the rating level of the live content may change (e.g., from TV-G to TV-MA) at any time.

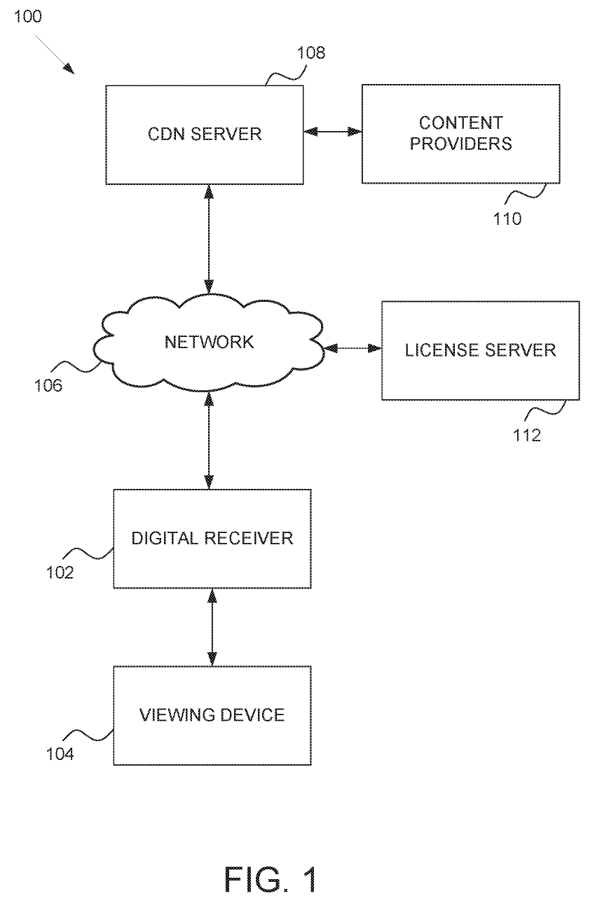

With reference to FIG. 1, an embodiment of an example environment 100 that enables providing access to live content over the Internet based on a user setting and a rating level of the live content is shown. In example embodiments, a digital receiver 102 provides access to live content and manages determination of whether a user is allowed to view the live content. In one embodiment, the digital receiver 102 is a set-top box. The digital receiver 102 is coupled to a viewing device 104 (e.g., a television or monitor) on which the user can view the live content. In some embodiments, the digital receiver 102 (e.g., operations of the digital receiver 102) may be combined with the viewing device 104 (e.g., a smart television, a tablet, or smartphone).

In example embodiments, the digital receiver 102 accesses (e.g., pulls, receives, retrieves) content via a network 106 from a content distribution network (CDN) server 108. The CDN server 108 may obtain the content from one or more content providers 110. In example embodiments, the CDN server 108 may be associated with a third party service (e.g., Netflix, Hulu, YouTube, Amazon,) that stores and provides content, such as, for example but not limited to, over-the-top (OTT) content, video-on-demand (VOD) content, Internet content, or broadcast content to the digital receiver 102 via the network 106. The content comprises text, images, audio, and/or video content (e.g., movies, television shows, videos), and in example embodiments comprises live (e.g., in real-time) content.

One or more portions of the network 106 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a WiMax network, a satellite network, a cable network, a broadcast network, another type of network, or a combination of two or more such networks. Any one or more portions of the network 106 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

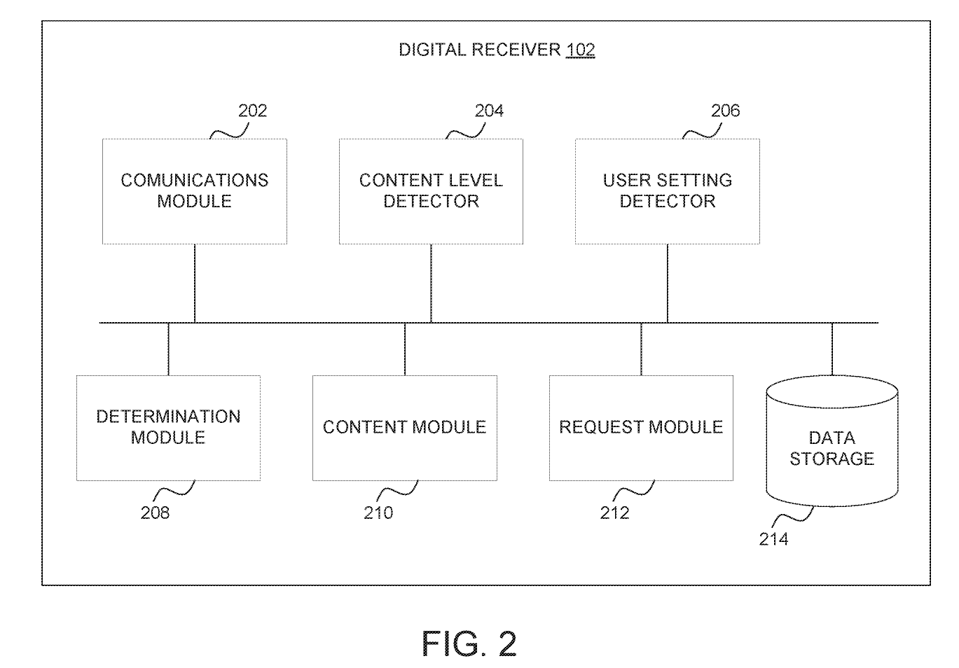

In example embodiments, the digital receiver 102 receives an indication of a license rotation from the CDN server 108. The indication may be sent when the content will change (e.g., from a first content item to a second content item) or when a rating level of a live content stream will change (e.g., from a first content item to a second content item having a different rating level than the first content item). In alternative embodiments, the content providers 110 provide the live content to the digital receiver 102 without having to go through the CDN server 108. In these embodiments, the content provider 110 provides the indication of license rotation when the content changes or a rating level of the content changes. In response to receiving the indication, the digital receiver 102 obtains a (new) license from a license server 112. In some cases, challenges may be exchanged between the digital receiver 102 and the license server 112 to verify the digital receiver 102 and determine the digital receiver 102 has authorization for the license. The operations of the digital receiver 102 will be discussed in more detail in connection with FIG. 2 below.

It is noted that the environment 100 shown in FIG. 1 is merely an example. For instance, any number of CDN servers 108, content providers 110, and license servers 112 may be embodied within the environment 100. Additionally, some components of the environment 100 may be combined. For example, the functions of the digital receiver 102 may be embodied within the viewing device 104 to form a single device, such as a smart television, tablet, smartphone, or any other device that is capable of obtaining, rendering, and displaying content. Moreover, the functions described herein for any single system or machine may be subdivided among multiple systems or machines.

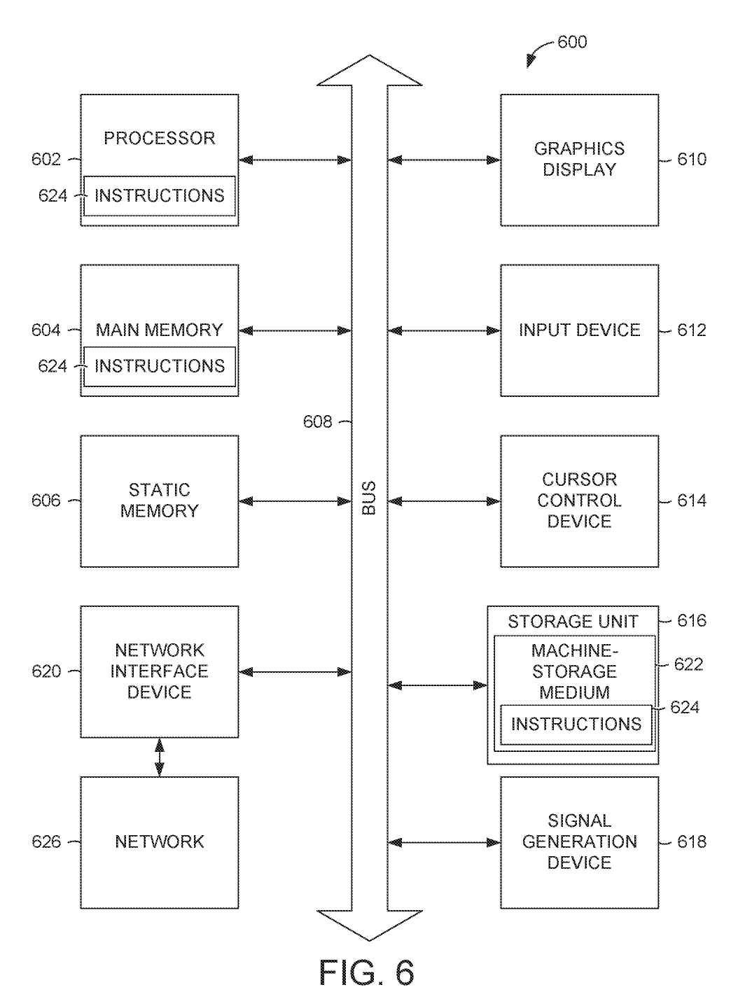

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

FIG. 2 is a block diagram illustrating an example embodiment of components within the digital receiver 102 in accordance with an example embodiment. In example embodiments, the digital receiver 102 manages access to live content streamed over the network 106 and, in particular, live content having different content rating levels. To enable these operations, the digital receiver 102 comprises a communications module 202, a content level detector 204, a user setting detector 206, a determination module 208, a content module 210, a request module 212, and a data storage 214 all of which may be configured to communicate with each other (e.g., over a bus, shared memory, or a switch).

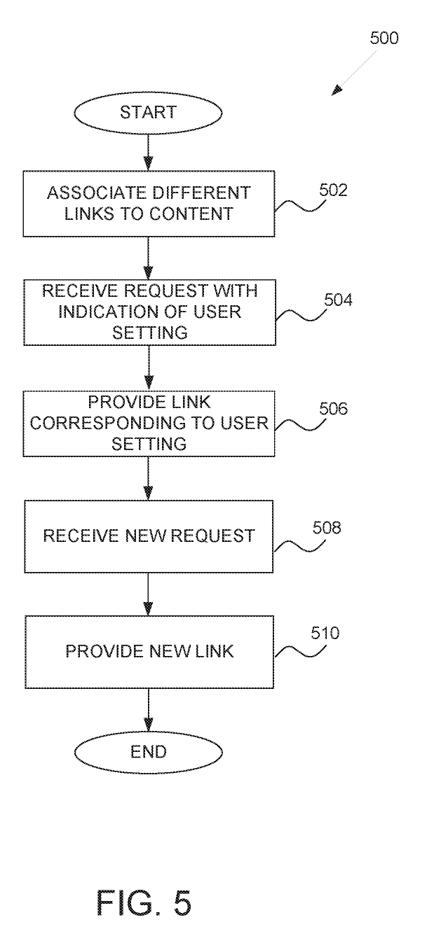

The communications module 202 is configured to exchange communications with other components in the environment 100. Accordingly, the communications module 202 receives an indication of a license rotation (e.g., a message indicating the license rotation). The indication may include an identifier of a new license (or next license) for upcoming content (e.g., content that will be streamed next). In example embodiments, the indication of the license rotation is sent by the CDN server 108 when the rating level in the content stream will change (e.g., from a first content item to a second content item, wherein the second content item has a different rating level than the first content item). In response to receiving the indication, the communications module 202 accesses (e.g., obtains, retrieves, receives) the new license from the license server 112 based on the identifier. In some embodiments, the communications module 202 generates and transmits a request to the CDN server 108 for content when a change in user setting is detected by the digital receiver 102 as will be discussed in more detail in connection with FIG. 5 below.

The content level detector 204 is configured to determine a rating level of content that will be streamed in the live content stream. In example embodiments, the content level detector 204 extracts, from a field in the license (e.g., a rating level field), a rating level of the content. The field in the license is added by the license server 112 when the license is generated in accordance with some embodiments. In one example, rating levels for content may correspond to television parental guidelines (e.g., ratings of TV-G, TV-PG, TV-14, TV-MA).

The user setting detector 206 is configured determine a user setting for the user. The user setting indicates a maximum (or highest) rating level the user is allowed to view. In example embodiments, the user setting is identified from a user profile of the user stored in the data storage 214. The user may log in, or otherwise identify themselves, to the digital receiver 102 when the user first accesses the digital receiver 102. As such, the digital receiver 102 (e.g., the user setting detector 206) identifies the user and can access their user profile to determine the user setting.

The determination module 208 is configured to make the determination as to whether the user setting for the user is at a level equal to or greater than the rating level of the content. For example, if the user is a teenager, the user setting, obtained from the user profile, may be set to TV-PG. As a result, the teenager is allowed to view any content with a rating level less than or equal to the user setting of TV-PG. Therefore, based on the U.S. television parental guidelines, the teenager is allowed to view content having a rating level of, for example, TV-G and TV-PG, but is not allowed to view content with a rating level greater than the user setting (e.g., content with rating level of TV-14 and TV-MA).

The content module 210 is configured to control access to the live content. Based on the determination performed by the determination module 208, the content module 210 may continue to allow a live content stream to be displayed or may block the live content stream. If the content is blocked, the content module 210 may cause presentation of a message on the viewing device 104 indicating that content in the live content stream is not appropriate for the user. In some embodiments, the content module 210 requests an access code (e.g., PIN) from the user in order to continue access to the live content stream. In these embodiments, the content module 210 instructs the viewing device 104 to display the request for the access code. In some cases, the content module 210 may block access to the live content by transmitting a signal to an application presenting the live content stream that causes the application to stop presenting the live content stream.

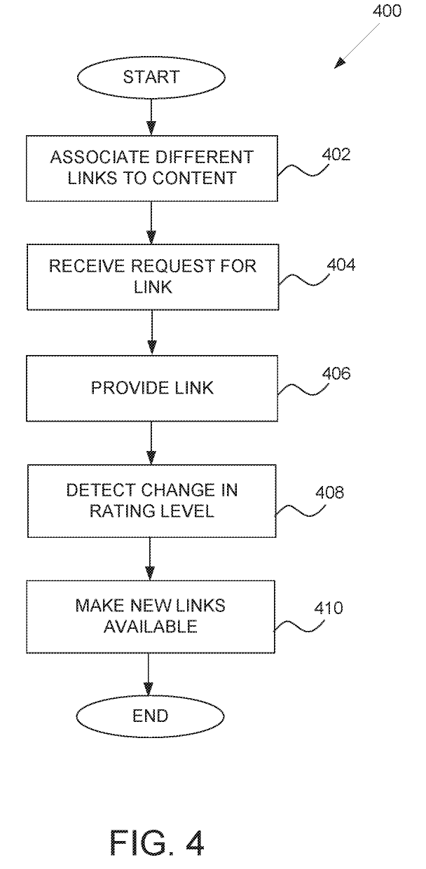

The request module 212 is configured to generate requests for links to content from the CDN server 108. In example embodiments, the request module 212 generates the request in response to detection of a change in the user setting at the digital receiver 102 (e.g., caused by a change in the user at the digital receiver 102). The operations of the request module 212 will be discussed in more detail in connection with FIG. 4 and FIG. 5 below.

Any one or more of the components (e.g., modules, detectors) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that module. Accordingly, different components described herein may include and configure different arrangements of the processors at different points in time or a single arrangement of the processors at different points in time. Each component (e.g., module) described herein is an example of a means for performing the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices.

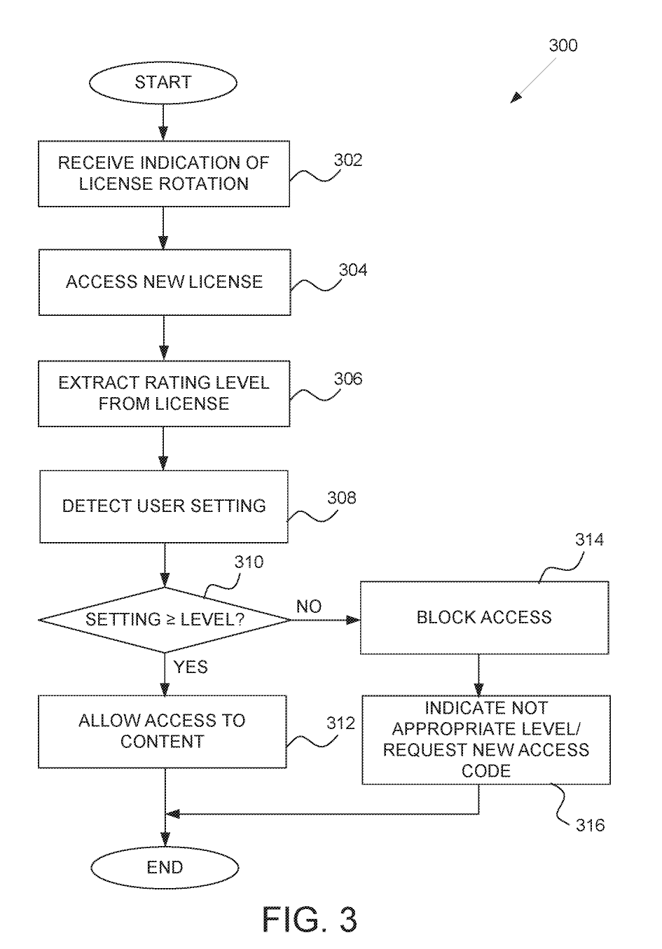

FIG. 3 is a flow diagram of an example method 300 for providing access to live content based on license rotation. In example embodiments, the method 300 is performed in part or in whole by components of the digital receiver 102. Accordingly, the method 300 is described by way of example with reference to the digital receiver 102. However, it shall be appreciated that at least some of the operations of the method 300 may be deployed on various other hardware configurations or be performed by similar components residing elsewhere in the environment 100. Therefore, the method 300 is not intended to be limited to the digital receiver 102.

In operation 302, the communications module 202 receives an indication of a license rotation (e.g., a message indicating a new license is needed for upcoming content). In example embodiments, the indication of the license rotation is triggered by a change in the live content stream from a first content item to a second content item or by a change in the rating level of the content that will be streamed. The indication includes an identifier of a new license for content (e.g., second content item) that will be streamed next.

In operation 304, the new license is accessed (e.g., obtained, retrieved, received) by the digital receiver 102 (e.g., the communications module 202) from the license server 112 using the identifier received in the indication. In example embodiments, the license comprises a plurality of fields including a rating level field indicating a rating level of the corresponding content. The rating level field is added by the license server 112 when the license is generated by the license server 112 in accordance with some embodiments.

In operation 306, the rating level for the content that will be streamed in the live content stream is extracted by the content level detector 204 (e.g., from the rating level field). In one example, rating levels for the content correspond to the U.S. television parental guidelines (e.g., ratings of TV-Y, TV-Y7, TV-G, TV-PG, TV-14, TV-MA). In another example, the rating levels corresponding to U.S. movie ratings (e.g., G, PG, PG-13, R, NC-17). Further still, the rating levels may correspond to other regional (e.g., European) rating guidelines or advisories.

In operation 308, the user setting detector 206 detects a user setting for a current user logged in or otherwise identified to the digital receiver 102. The user setting indicates a maximum rating level the user is allowed to view. In example embodiments, the user setting detector 206 access a user profile of the user stored in the data storage 214. The user setting detector 206 then identifies the user setting indicated in the user profile.

In operation 310, the determination module 208 determines whether the user setting for the user is at a level equal to or greater than the rating level of the content. If the user setting for the user is equal to or greater than the rating level of the content, then the content module 210 allows continued access to the live content (e.g., allows the presentation of the content on the viewing device 104). For example, if the user setting obtained from the user profile is TV-PG or PG, and the rating level of the content is less than or equal to the user setting of TV-PG or PG (e.g., TV-Y, TV-Y7, TV-G, TV-PG, TV-14, G, or PG), the content module 210 allows the user to continue viewing the live content.

However, if the user setting is at a level less than the rating level of the content, then the content module 210 blocks access to the live content in operation 314. If the content is blocked, the content module 210 may cause presentation of a message on the viewing device 104 indicating that content in the live content stream is not appropriate for the user in operation 316. Additionally or alternatively, the content module 210 requests an access code (e.g., that corresponds to a user with a higher user setting) from the user in order for the user to continue viewing to the live content stream in operation 316.

FIG. 4 is a flow diagram of an example method 400 for providing access to live content using links. In example embodiments, the method 400 is performed in part or in whole by the CDN server 108. Accordingly, the method 400 is described by way of example with reference to the CDN server 108. However, it shall be appreciated that at least some of the operations of the method 400 may be deployed on various other hardware configurations or be performed by similar components residing elsewhere in the environment 100. Therefore, the method 400 is not intended to be limited to the CDN server 108.

In operation 402, the CDN server 108 associates different links (e.g., URLs) to content. In example embodiments, the CDN server 108 maintains links pointing to the same content, a manifest of the same content, or both. Using the U.S. television parental guidelines (e.g., ratings of TV-Y, TV-Y7, TV-G, TV-PG, TV-14, TV-MA), for a piece of content that has a rating level of “TV-G,” TV-G, TV-PG, TV-14, and TV-MA links will all point to the TV-G content. However, if a piece of content has a rating level of “TV-14,” then only the TV-14 and TV-MA links will point to the TV-14 content. In a Linux environment, the links comprise symbolic links.

In operation 404, the CDN server 108 receives a request for content with an indication of a user setting. In example embodiments, the request is generated by the request module 212 and includes a value that corresponds to a highest level (e.g., the user setting) that can be viewed by the user. For instance, when the user first logs into the receiver device 102 and attempts to access content, the request module 212 will append the user setting to a HTTP request for content, and the communication module 202 transmits the HTTP request to the CDN server 108. For example, if the user wants to watch the ABC network via OTT, the link for ABC OTT may be http://ABC-live.mpd. Assuming that the digital receiver 102 is set to TV-14 (e.g., user setting detector 206 determines the user setting is TV-14), the request module 212 will create a request that is http://ABC-live-tv-14.mpd.

In operation 406, the CDN server 108 provides the link that corresponds to the user setting. Continuing with the above example, the CDN server 108 provides the TV-14 link (e.g., link that provides access to content that is rated TV-G, TV-PG, and TV-14) to the receiver device 102. If the user setting is less than the rating level of the content (e.g., ABC-live has rating level of TV-PG and the user setting is TV-G), the CDN server 108 returns an error message indicating that the content not found, not available, or not applicable to the user.

In operation 408, the CDN server 108 detects a change in rating level of the content being presented on a particular “channel” (e.g., ABC). For example, the content of the live content stream may change from a rating level of TV-PG to TV-MA. Based on the change, the link currently being used by the receiver device 102 is replaced by a new link for the new content (operation 410). For example, if the rating level changes from TV-PG to TV-14, new links are associated with the content (e.g., as discussed in operation 402), and a link that corresponds to the user setting is returned to the receiver device 102. If the user setting is less than the rating level of the new content, a message (e.g., an error message) indicating that content in the live content stream is not appropriate for the user may be caused to be presented (e.g., by the CDN server 108 or the content module 210) on the digital receiver 102. Additionally or alternatively, a request for an access code from the user may be made if the user desires to continue viewing the live content stream. The access code may comprise a password or PIN that corresponds to a user with a higher user setting (e.g., a user setting that will allow viewing of the live content).

FIG. 5 is a flow diagram of an alternative method 500 for providing access to live content using links. In example embodiments, the method 500 is performed in part or in whole by components of the CDN server 108. Accordingly, the method 500 is described by way of example with reference to the CDN server 108. However, it shall be appreciated that at least some of the operations of the method 500 may be deployed on various other hardware configurations or be performed by similar components residing elsewhere in the environment 100. Therefore, the method 500 is not intended to be limited to the CDN server 108.

The beginning operations of the method 500 are similar to those of the method 400. As such, in operation 502, the CDN server 108 associates different links (e.g., URLs) to content. In operation 504, the CDN server 108 receives a request for content that implies a user setting. In operation 506, the CDN server 108 provides the link that corresponds to the user setting.

In operation 508, the CDN server 108 receives a new request due to a change in the user setting at the digital receiver 102. For example, the user at the digital receiver 102 may change. Based on the change in the user setting, the original link is broken by the digital receiver 102, and new request generated and sent by the digital receiver 102. Using the ABC example from above, the request received in operation 504 may be http://ABC-live-tv-14.mpd, but after the change in user, the new request may be http://ABC-live-tv-G.mpd for a user setting of TV-G of the new user.

Subsequently, in operation 510, a new link corresponding to the new user setting is provided (or initiated) by the CDN server 108. Continuing the example, the new link will be the TV-G link to content. As a result, the new user can only view content having a rating level of TV-G or lower (e.g., TV-Y, TV-Y7). If the new request implies a user setting that is less than the rating level of the requested content, a message (e.g., an error message) indicating that content in the live content stream is not appropriate for the user may be caused to be presented (e.g., by the CDN server 108 or the content module 210) on the digital receiver 102. Additionally or alternatively, a request for an access code from the user may be made if the user desires to continue viewing the live content stream. The access code may comprise a password or PIN that corresponds to a user with a higher user setting (e.g., a user setting that will allow viewing of the live content).

FIG. 6 is a block diagram illustrating components of a machine 600, according to some example embodiments, able to read instructions 624 from a machine-storage medium 622 (e.g., a non-transitory machine-storage medium, a machine-readable storage medium, a computer-readable storage medium, or any suitable combination thereof) and perform any one or more of the methodologies discussed herein, in whole or in part. Specifically, FIG. 6 shows the machine 600 in the example form of a computer device (e.g., a computer) within which the instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute the flow diagrams of FIGS. 3-5. The instructions 624 can transform the general, non-programmed machine 600 into a particular machine (e.g., specially configured machine) programmed to carry out the described and illustrated functions in the manner described.

In alternative embodiments, the machine 600 operates as a standalone device or may be connected (e.g., networked) to other machines. The machine 600 may be a server computer, a client computer, a personal computer (PC), a tablet computer, a laptop computer, a netbook, a set-top box (e.g. STB), a personal digital assistant (PDA), a cellular telephone, a smartphone, a web appliance, a network router, a network switch, a network bridge, a power adapter, or any machine 600 capable of executing the instructions 624, sequentially or otherwise, that specify actions to be taken by that machine 600. Further, while only a single machine 600 is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more modules (e.g., software modules) described herein.

The machine 600 may further include a graphics display 610 (e.g., a plasma display panel (PDP), a light emitting diode (LED) display, a liquid crystal display (LCD), a projector, a cathode ray tube (CRT), or any other display capable of displaying graphics or video). The machine 600 may also include an alphanumeric input device 612 (e.g., a keyboard or keypad), a cursor control device 614 (e.g., a mouse, a touchpad, a trackball, a joystick, a motion sensor, an eye tracking device, or other pointing instrument), a storage unit 616, a signal generation device 618 (e.g., a sound card, an amplifier, a speaker, a headphone jack, or any suitable combination thereof), and a network interface device 620.

The storage unit 616 includes the machine-storage medium 622 (e.g., a tangible machine-readable storage medium) on which are stored the instructions 624 embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered machine-storage media 622 (e.g., tangible and non-transitory machine-storage media).

In some example embodiments, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions and Machine-Storage Medium

The various memories (i.e., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed embodiments.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 622 specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., WiFi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium 622 or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 602 or a group of processors 602) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the inventive subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

### Examples

Example 1 is a method for providing access to digital content based on a content rating system using license rotation. The method comprises receiving, by a digital receiver, an indication of a license rotation during presentation of a live content stream delivered over the Internet to the digital receiver of a user; in response to the receiving of the indication, accessing, from a license server, a license corresponding to the license rotation; extracting, by a processor of the digital receiver, a rating level of content from a field of the license; comparing, by the digital receiver, a user setting for the user with the rating level of the content; and based on the comparing, determining whether to provide continued access to the live content stream by the digital receiver.

In example 2, the subject matter of example 1 can optionally include wherein the comparing comprises determining that the user setting is equal to or greater than the rating level of the content; and the determining whether to provide the continued access comprises providing the continued access to the live content stream is in response to the user setting being equal to or greater than the rating level of the content

In example 3, the subject matter of examples 1-2 can optionally include wherein the comparing comprises determining that the user setting is less than the rating level of the content, the method further comprising, in response to the user setting being less than the rating level of the content, causing presentation of a message indicating that content in the live content stream is not appropriate for the user.

In example 4, the subject matter of examples 1-3 can optionally include wherein the comparing comprises determining that the user setting is less than the rating level of the content, the method further comprising, in response to the user setting being less than the rating level of the content, requesting an access code from the user in order to continue access to the live content stream.

In example 5, the subject matter of examples 1-4 can optionally include wherein the comparing comprises determining that the user setting is less than the rating level of the content; and the determining whether to provide the continued access comprises blocking the continued access to the live content stream in response to the user setting being less than the rating level of the content.

In example 6, the subject matter of examples 1-5 can optionally include wherein the blocking of the continued access comprises transmitting a signal to an application presenting the live content stream that causes the application to stop presenting the live content stream on a viewing device.

In example 7, the subject matter of examples 1-6 can optionally include wherein the indication of the license rotation is triggered by a change in the live content stream from a first content item to a second content item, wherein the second content item has a different rating level than the first content item.

Example 8 is a system for providing access to digital content based on a content rating system using license rotation. The system includes one or more hardware processors and a storage device storing instructions that configure the one or more hardware processors to perform operations comprising receiving an indication of a license rotation during presentation of a live content stream delivered over the Internet to the digital receiver of a user; in response to the receiving of the indication, accessing, from a license server, a license corresponding to the license rotation; extracting a rating level of content from a field of the license; comparing a user setting for the user with the rating level of the content; and based on the comparing, determining whether to provide continued access to the live content stream.

In example 9, the subject matter of example 8 can optionally include wherein the comparing comprises determining that the user setting is equal to or greater than the rating level of the content; and the determining whether to provide the continued access comprises providing the continued access to the live content stream is in response to the user setting being equal to or greater than the rating level of the content.

In example 10, the subject matter of examples 8-9 can optionally include wherein the comparing comprises determining that the user setting is less than the rating level of the content; and the operations further comprise, in response to the user setting being less than the rating level of the content, causing presentation of a message indicating that content in the live content stream is not appropriate for the user.

In example 11, the subject matter of examples 8-10 can optionally include wherein the comparing comprises determining that the user setting is less than the rating level of the content; and the operations further comprise, in response to the user setting being less than the rating level of the content, requesting an access code from the user in order to continue access to the live content stream.

In example 12, the subject matter of examples 8-11 can optionally include wherein the comparing comprises determining that the user setting is less than the rating level of the content; and the determining whether to provide the continued access comprises blocking the continued access to the live content stream in response to the user setting being less than the rating level of the content.

In example 13, the subject matter of examples 8-12 can optionally include accessing a user profile of the user; and determining the user setting from the user profile.

In example 14, the subject matter of examples 8-13 can optionally include wherein the indication of the license rotation is triggered by a change in the live content stream from a first content item to a second content item, wherein the second content item has a different rating level than the first content item.

Example 15 is machine-storage medium storing instructions that when executed by one or more hardware processors of a machine, cause the machine to perform operations comprising receiving an indication of a license rotation during presentation of a live content stream delivered over the Internet to the digital receiver of a user; in response to the receiving of the indication, accessing, from a license server, a license corresponding to the license rotation; extracting a rating level of content from a field of the license; comparing a user setting for the user with the rating level of the content; and based on the comparing, determining whether to provide continued access to the live content stream.

In example 16, the subject matter of example 15 can optionally include wherein the comparing comprises determining that the user setting is equal to or greater than the rating level of the content; and the determining whether to provide the continued access comprises providing the continued access to the live content stream is in response to the user setting being equal to or greater than the rating level of the content.

In example 17, the subject matter of examples 15-16 can optionally include wherein the comparing comprises determining that the user setting is less than the rating level of the content; and the operations further comprise, in response to the user setting being less than the rating level of the content, causing presentation of a message indicating that content in the live content stream is not appropriate for the user.

In example 18, the subject matter of examples 15-17 can optionally include wherein the comparing comprises determining that the user setting is less than the rating level of the content; and the operations further comprise, in response to the user setting being less than the rating level of the content, requesting an access code from the user in order to continue access to the live content stream.

In example 19, the subject matter of examples 15-18 can optionally include wherein the comparing comprises determining that the user setting is less than the rating level of the content; and the determining whether to provide the continued access comprises blocking the continued access to the live content stream in response to the user setting being less than the rating level of the content.

In example 20, the subject matter of examples 15-19 can optionally include wherein the indication of the license rotation is triggered by a change in the live content stream from a first content item to a second content item, wherein the second content item has a different rating level than the first content item.

What is claimed is:

1. A method comprising:
receiving, by a digital receiver, an indication of a license rotation during presentation of a live content stream delivered over the Internet to the digital receiver of a user;
in response to the receiving of the indication, accessing, from a license server, a license corresponding to the license rotation;
extracting, by a processor of the digital receiver, a rating level of content from a field of the license;
comparing, by the digital receiver, a user setting for the user with the rating level of the content; and
based on the comparing, determining whether to provide continued access to the live content stream by the digital receiver.

2. The method of claim 1, wherein:
the comparing comprises determining that the user setting is equal to or greater than the rating level of the content; and
the determining whether to provide the continued access comprises providing the continued access to the live content stream is in response to the user setting being equal to or greater than the rating level of the content.

3. The method of claim 1, wherein the comparing comprises determining that the user setting is less than the rating level of the content, the method further comprising, in response to the user setting being less than the rating level of the content, causing presentation of a message indicating that content in the live content stream is not appropriate for the user.

4. The method of claim 1, wherein the comparing comprises determining that the user setting is less than the rating level of the content, the method further comprising, in response to the user setting being less than the rating level of the content, requesting an access code from the user in order to continue access to the live content stream.

5. The method of claim 1, wherein:
the comparing comprises determining that the user setting is less than the rating level of the content; and
the determining whether to provide the continued access comprises blocking the continued access to the live content stream in response to the user setting being less than the rating level of the content.

6. The method of claim 5, wherein the blocking of the continued access comprises transmitting a signal to an application presenting the live content stream that causes the application to stop presenting the live content stream on a viewing device.

7. The method of claim 1, wherein the indication of the license rotation is triggered by a change in the live content stream from a first content item to a second content item, wherein the second content item has a different rating level than the first content item.

8. A system comprising:
one or more hardware processors; and
a storage device storing instructions that configure the one or more hardware processors to perform operations comprising:
receiving an indication of a license rotation during presentation of a live content stream delivered over the Internet to the digital receiver of a user;
in response to the receiving of the indication, accessing, from a license server, a license corresponding to the license rotation;
extracting a rating level of content from a field of the license;
comparing a user setting for the user with the rating level of the content; and
based on the comparing, determining whether to provide continued access to the live content stream.

9. The system of claim 8, wherein:
the comparing comprises determining that the user setting is equal to or greater than the rating level of the content; and
the determining whether to provide the continued access comprises providing the continued access to the live content stream is in response to the user setting being equal to or greater than the rating level of the content.

10. The system of claim 8, wherein:
the comparing comprises determining that the user setting is less than the rating level of the content; and
the operations further comprise, in response to the user setting being less than the rating level of the content, causing presentation of a message indicating that content in the live content stream is not appropriate for the user.

11. The system of claim 8, wherein:
the comparing comprises determining that the user setting is less than the rating level of the content; and
the operations further comprise, in response to the user setting being less than the rating level of the content, requesting an access code from the user in order to continue access to the live content stream.

12. The system of claim 8, wherein:
the comparing comprises determining that the user setting is less than the rating level of the content; and
the determining whether to provide the continued access comprises blocking the continued access to the live content stream in response to the user setting being less than the rating level of the content.

13. The system of claim 8, wherein the operations further comprise:
accessing a user profile of the user; and
determining the user setting from the user profile.

14. The system of claim 8, wherein the indication of the license rotation is triggered by a change in the live content stream from a first content item to a second content item, wherein the second content item has a different rating level than the first content item.

15. A machine-storage medium storing instructions that when executed by one or more hardware processors of a machine, cause the machine to perform operations comprising:
receiving an indication of a license rotation during presentation of a live content stream delivered over the Internet to the digital receiver of a user;
in response to the receiving of the indication, accessing, from a license server, a license corresponding to the license rotation;
extracting a rating level of content from a field of the license;
comparing a user setting for the user with the rating level of the content; and
based on the comparing, determining whether to provide continued access to the live content stream.

16. The machine-storage medium of claim 15, wherein:
the comparing comprises determining that the user setting is equal to or greater than the rating level of the content; and
the determining whether to provide the continued access comprises providing the continued access to the live content stream is in response to the user setting being equal to or greater than the rating level of the content.

17. The machine-storage medium of claim 15, wherein:
the comparing comprises determining that the user setting is less than the rating level of the content; and
the operations further comprise, in response to the user setting being less than the rating level of the content, causing presentation of a message indicating that content in the live content stream is not appropriate for the user.

18. The machine-storage medium of claim 15, wherein:
the comparing comprises determining that the user setting is less than the rating level of the content; and
the operations further comprise, in response to the user setting being less than the rating level of the content, requesting an access code from the user in order to continue access to the live content stream.

19. The machine-storage medium of claim 15, wherein:
the comparing comprises determining that the user setting is less than the rating level of the content; and
the determining whether to provide the continued access comprises blocking the continued access to the live content stream in response to the user setting being less than the rating level of the content.

20. The machine-storage medium of claim 15, wherein the indication of the license rotation is triggered by a change in the live content stream from a first content item to a second content item, wherein the second content item has a different rating level than the first content item.
